(19) United States
(12) Patent Application Publication
(10) Pub. No.: US 2017/0116386 A1
(43) Pub. Date: Apr. 27, 2017

(54) CELLULAR-AGE META-ANALYSIS SYSTEM

(71) Applicant: UNION APPLIED GENE INC., TAIPEI CITY (TW)

(72) Inventor: Hung-Wei SHU, TAIPEI CITY (TW)

(21) Appl. No.: 14/918,850

(22) Filed: Oct. 21, 2015

(51) Int. Cl. G06F 19/00

(52) U.S. Cl. CPC G06F 19/3431

(57) ABSTRACT

A cellular-age meta-analysis system performs a meta-analysis method on personal information and telomere assay figures, so as to rapidly and accurately obtain information on personal aging degree evaluation and on preventive and improving recommendation according to on analytic figures related to cellular age and a cellular-aging index. With the information and cellular aging analytic figures, a user is aware of his/her potential age and risks, and knows whether his/her current physiological conditions shows a trend of premature aging or not. This encourages the user to adopt a reliable, appropriate personalized healthcare solution that prevents premature aging and avoid adverse lifestyle and environmental factors on a daily basis, thereby protecting his/her body from abnormal aging rate, and improving health and decreasing incidence of associated diseases.

### BACKGROUND OF THE INVENTION

Field of the Invention

The present invention relates to finding out cellular age and a cellular-aging index, and more particularly to a cellular-age meta-analysis system that is based on personal information and telomere assay figures and uses a meta-analysis server to perform interactive calculation.

Related Prior Art

By calculating years that has lapsed since an individual's birth, it is possible to know the year-based age (chronological age) of the individual. Recently, the concept of “potential age”, which is different from chronological age, has been increasingly discussed. Calculated differently from chronological age, the so-called potential age is an age value of an individual's body determined by considering the aging factors acting on the individual, and generally includes two aspects: “cellular age” and “physiological age”. The term “cellular age” stems from the theory of “cellular aging” and its related research. It is found in the past biological research into cells that cells after long-term culture tend to have morphological change that brings about slower metabolism and reduced cloning, which are symptoms reflecting the aging state of cells, also known as “cellular aging”. More recent studies suggest that cellular aging may be related to the shortened length of “telomeres”, which refer to a unique structure existing at the terminal of a DNA. At present, the commercially available assays for finding out potential age are nothing about biological tests focused on “cellular age”, but actually evaluation of “physiological age” based on data collected from surveys about respondents' personal lifestyle and physical conditions. A “physiological age” assay obtains year-based age and is in nature a ranking work on the subject's personal living environment and habit. On the other hand, a “cellular age” assay directly measures cellular aging signs such as a shortened telomere, and uses algorithm and analysis to figure out how the subject's cells age. In brief, “physiological age” is more about evaluating the factors causing the subject's “potential age”, while “cellular age” discloses an analytic result of the current cellular aging state. Since a person's “cellular age” better represents his/her current actual aging state, knowing cellular age is helpful to learn the subject's physiological conditions and whether his/her cells are aging at an increased rate. If yes, the subject may be suggested improving his/her living habit and environmental factors, thereby preventing abnormal aging rate.

However, the existing assays for measuring potential age are mostly focused on physiological age, and thus fail to provide evidence whether the subject's lifestyle or personal physiological conditions are harming his/her cells. Also, physiological age is difficult to be quantified into an index reflecting the relation between the subject's year-based age and actual aging state, so is not a good reference for determining the subject's potential age. Hence, it is important to find a solution to use a “cellular age” assay to evaluate the actual aging state of a person. The solution may further involve calculating assay figures so as to provide information on the person's potential age, health and aging risks. With this information, healthcare personal can better draw up a personalized anti-aging, health-improving recommendation that well addresses the person's actual physiological conditions.

### SUMMARY

The present invention provides a cellular-age meta-analysis system with the objective to perform a meta-analysis method on personal information and telomere assay figures, so as to rapidly and accurately obtain information on personal aging degree evaluation and on preventive and improving recommendation according to on analytic figures related to cellular age and a cellular-aging index.

For achieving the foregoing objective, the disclosed cellular-age meta-analysis system includes a user interface, a meta-analysis server, a telomere length trend database, an age-telomere relation database, a report content database and an analytic result database, therein the user interface being used to enter at least one personal information and at least one telomere length assay figure to the meta-analysis server; the meta-analysis server sending the personal information and the telomere length assay figure to the telomere length trend database and the age-telomere relation database for interactive calculation, so as to obtain a personal cellular age figure and a cellular aging figure; the report content database receiving the personal information, the personal cellular age figure and the cellular aging figure and performing unified calculation, so as to obtain a personal aging degree evaluation datum and a preventive and improving recommendation datum; and the meta-analysis server extracting the cellular aging figure, the personal aging degree evaluation datum and the preventive and improving recommendation datum, performing processing and formalization to output a cellular-age report, and saving the cellular-age report into the analytic result database.

Preferably, the personal information includes a name, an ID number, a gender and a year of birth.

Preferably, the telomere length assay figure includes an ID number, a telomere assay figure and an acidic ribosomal protein P0 gene assay figure.

Preferably, the report content database includes an aging-degree evaluation datum area and a preventive and improving recommendation datum area.

Preferably, the cellular-age report includes a report item set and a report content set. The report item set includes a cellular-age information, a cellular-aging index, an aging-degree evaluation and a personal health preventive and improving recommendation. An analytic and evaluative result of the report item set serves as a reference for a client to improve health thereof.

### BRIEF DESCRIPTION OF THE DRAWINGS

FIG. 1 is a block diagram of the present invention.

FIG. 2 is a graph showing distribution of telomere lengths among males as referred to in the present invention.

FIG. 3 is a graph showing distribution of telomere lengths among females as referred to in the present invention.

FIG. 4 is a graph showing telomere data of people at age 25 as recorded in an age-telomere relation database of the present invention.

FIG. 5 is a graph showing telomere data of people at age 41 as recorded in an age-telomere relation database of the present invention.

FIG. 6 is a flowchart of the method of the present invention.

### DETAILED DESCRIPTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

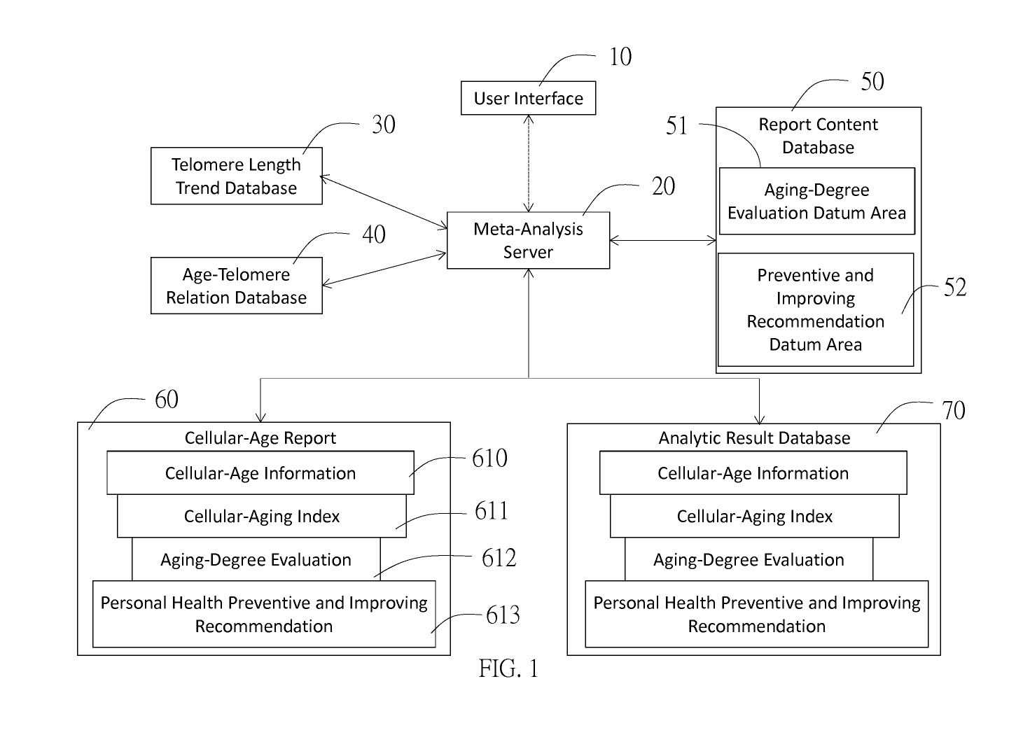

As shown in FIG. 1, according to one embodiment of the present invention, a cellular-age meta-analysis system comprises: a user interface 10, a meta-analysis server 20, a telomere length trend database 30, an age-telomere relation database 40, a report content database 50, a cellular-age report 60 and an analytic result database 70.

The user interface 10 provides a table for a user to input data, which includes at least a personal information 11 and at least a telomere length assay figure 12.

In the present embodiment, the personal information 11 includes: a name 110, an ID number 111, a gender 112 and a year of birth 113, as shown in Table 1:

The telomere length assay figure 12 includes: an ID number 120, a telomere assay figure 121 and an acidic ribosomal protein P0 gene assay figure 122 (RPLP0), as shown in Table 2:

A telomere is a six-base repetitive sequence (TTAGGG) located at the terminal of a chromosome, and works with telomere binding protein to form a protein-DNA complex, which is a special structure important to chromosomal protection. As proven by many studies, telomeres in cells become shorter as cells age. It is also found that shortened telomeres are responsible for some aging factors. Therefore, telomere length is regarded as an important indicator of cellular aging. Using a telomere assay to measure telomere length aids in evaluating the aging degree of cells, and thereby presents the big picture of the subject's health. An acidic ribosomal protein P0 gene is a single copy gene. Since there is only one copy in a cell, a higher count of this gene means there are more cells in the assayed sample, and vice versa. Therefore, the assay figure of the acidic ribosomal protein P0 gene is a reference for the quantity of cells. The assay result of telomeres refers to the base length of all the telomeres in a sample. Since the number of cells in the sample determines the assay figure, it is difficult to accurately evaluate the aging degree of a single cell depending only on the telomere assay figure 121. Thus, in addition to the assay result of telomeres, the present invention further uses the acidic ribosomal protein P0 gene assay figure 122 (RPLP0) in order to accurately evaluate the number of cells in the sample. Using the assay result of the acidic ribosomal protein P0 gene assay figures 122 (RPLP0) to normalize the assay result of telomeres, the telomere base length of a single cell can be obtained, so that reliable, accurate analysis of cellular aging is achievable.

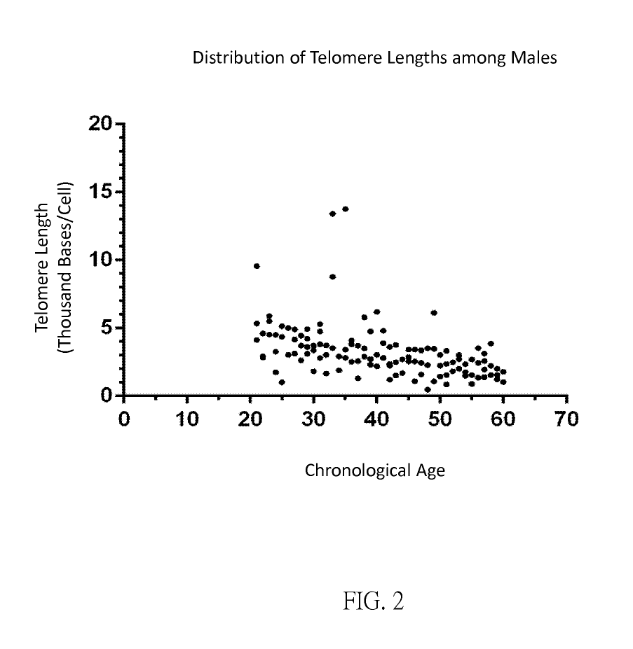

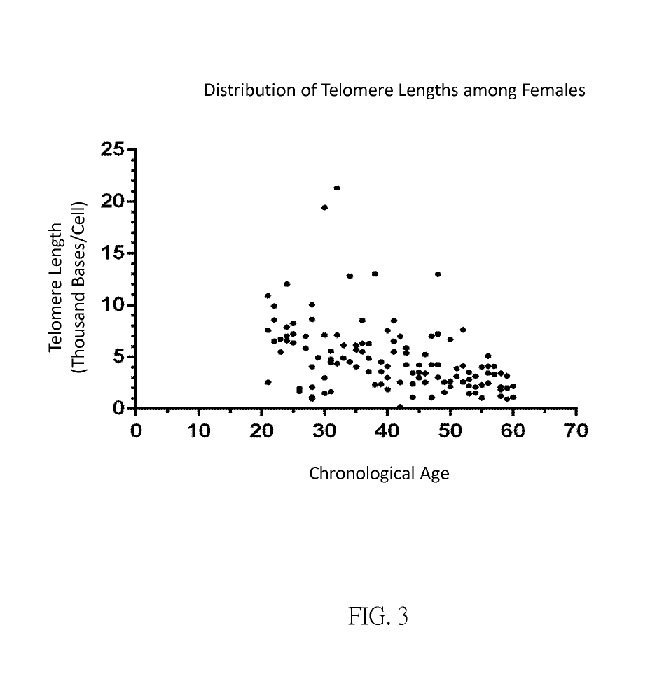

Referring to FIG. 2 and FIG. 3, the telomere assay figures 121 stored in the telomere length trend database 30 are from males and females of all ages, with the condition that they have good living habits and have neither major medical records nor serious aging factors. These assay figures are collected and converted graphically express specific trends. FIG. 2 is a graph showing distribution of telomere lengths among males. FIG. 3 is a graph showing distribution of telomere lengths among females. In the graphs, the X axis represents chronological age, and the Y axis represents telomere length (expressed in the unit of thousand bases/cell).

The meta-analysis server 20 then according to the gender 112 expressed in the personal information 11 performs analytic calculation using the telomere assay figure 121 and the telomere length trend database 30 corresponding to the gender 112. For example, the user inputs a telomere assay figure 121 for a man, and the analytic calculation will be performed using the male telomere length trend data as shown in FIG. 2. Where the man is normally healthy, the calculated cellular age should be equal to the chronological age. For a man who pays extra attention to health and anti-aging works such as taking exercise, and having balanced diet and nutritional supplements, the calculated cellular age may be younger than the chronological age. If the man has bad living habits and lives in an environment full of aging factors, the calculated cellular age may be older than his chronological age. In other words, analysis of the cellular age is useful to learn a person's actual aging state and health.

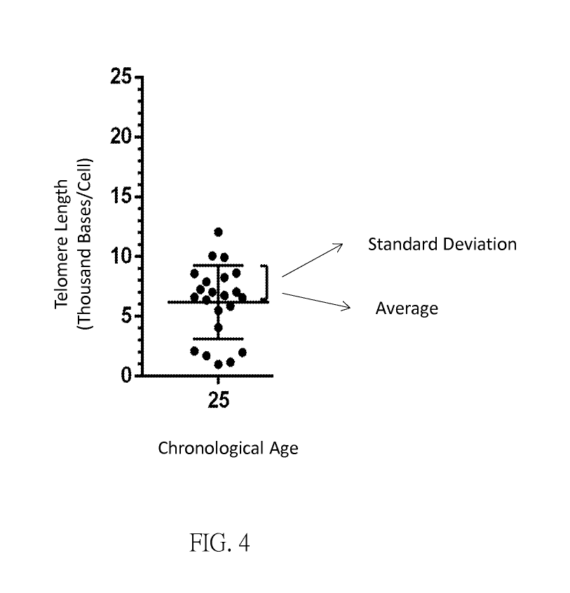

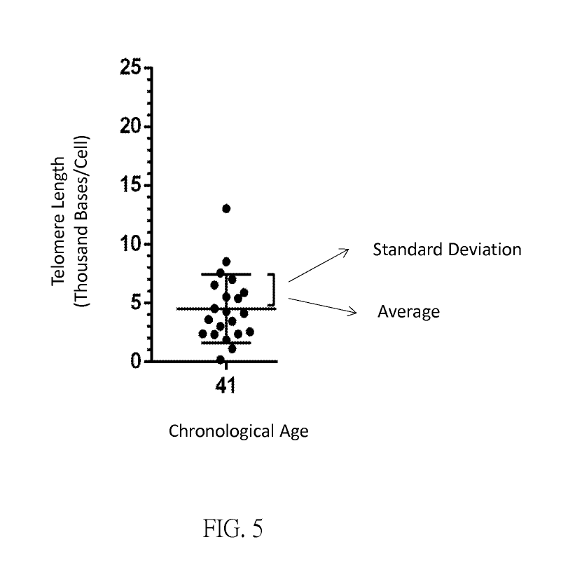

As shown in FIG. 4 and FIG. 5, the age-telomere relation database 40 provides a source of telomere length data of a coeval, healthy population. This, through comparison, the user's aging degree with respect to his/her peers can be determined. FIG. 4 is a graph showing telomere data of people at age 25 as recorded in an age-telomere relation database 40. FIG. 5 is a graph showing telomere data of people at age 41 as recorded in an age-telomere relation database 40. Therein, the X axis represents chronological age, and the Y axis represents telomere length (expressed in the unit of thousand bases/cell). Also shown in the graphs are averages and standard values. In addition to cellular age, the present invention also performs analysis of a cellular-aging index. Through comparative analysis of the telomere length data of a coeval, healthy population, it is possible to learn the user's aging degree with respect to his/her peers. The meta-analysis server 20 uses the year of birth 113 contained in the personal information to calculate the user's age, and then performs analytic calculation with the telomere assay figure 121 and the age-telomere relation database 40. For example, if a user enters a telomere assay figure of a chronological age of 25, this figure is compared to the telomere data of people at age 25 in the age-telomere relation database 40. The telomere data of people at age 25 in the age-telomere relation database 40 are visualized as shown in FIG. 4. Therein, Y axis represents telomere length (expressed in the unit of thousand bases/cell) with the average and the standard deviation provided. For example, a user enters a telomere assay figure of a chronological age of 41, this figure is compared to the telomere data of people at age 41 in the age-telomere relation database 40. The telomere data of people at age 41 in the telomere length trend database 30 are as shown in FIG. 5. The telomere assay FIGS. 121 of different chronological ages are compared to the averages and standard deviations of the telomere data of the corresponding chronological ages in the age-telomere relation database 40. By means of the statistical method known as stand score (z-score), a reliable cellular-aging index can be obtained. The cellular-aging index may be any of seven levels namely −3, −2, −1, 0, +1, +2, and +3. The level more negative indicates a lower aging degree in the coeval population, which means that the subject is physiologically younger and more healthy than his/her peers. The level more positive indicates a higher aging degree in the coeval population, which means that the subject is physiologically older and less healthy than his/her peers. Such a cellular-aging index thus provides a clear indicator showing how aged the subject's cells are.

The report content database 50 contains an aging-degree evaluation datum area 51 and a preventive and improving recommendation datum area 52. The aging-degree evaluation datum area 51 includes health analytic results for different cellular age ranges, and the preventive and improving recommendation datum area 52 includes cellular aging improving recommendations for different values of the cellular-aging index.

As shown in Table 3, the cellular-age report 60 includes a report item set 61 and a report content set 62. The report item set 61 includes four major items, namely cellular-age information 610, cellular-aging index 611, aging-degree evaluation 612 and personal health preventive and improving recommendation 613. The report content set 62 contains analytic and evaluative results of the report item set 61, serves as a reference for a client to improve health thereof

TABLE 3

| Report Item Set | Report Content Set |
|---|---|
| Cellular-Age | Your cellular age is 55. |
| Information | |
| Cellular-Aging | Your cellular-aging index is +2. |
| Index | |
| Aging-Degree | 1. You are older than your actual age |
| Evaluation | 2. You have physiological conditions of cellular |
| | age of 50~60, and the evaluation results of |
| | your health indicate that: |
| | Cardiovascular system: |
| | 1. you have arterial calcification, with larger |
| | arteries thickened by 40%; |
| | 2. you have risks of cardiovascular diseases; |
| | Digestive tract: |
| | 1. you have to take fecal occult blood test |
| | every year and sigmoidoscopy every 3-5 years; |
| | 2. you are likely to have polyps, and care your |
| | health; |
| | Muscles and bones: |
| | 1. Your physical ability and muscle strength |
| | are weakened; |
| | 2. Your bone mass decreases sharply; |
| | Facial skin |
| | 1. Your ability to synthesize collagen keeps |
| | degrading, and is lower than a half then that |
| | when you were young; |
| | 2. Wrinkles are getting deeper and wider; and |
| | 3. Aging spots appear. |
| Personalized | 1. Tips for improving your facial skin |
| Preventive And | Your physiological age is older than your |
| Improving | actual age. To have a good countenance, you |
| Recommendation | need to take good care of your facial skin and |
| | keep a regular daily routine. In addition to |
| | basic cleaning, moistening and sun-shielding, |
| | you need pay efforts to improve existing facial |
| | spots and wrinkles and to prevent new one to |
| | appear. |
| | 2. Tips for improving your cardiovascular |
| | system |
| | When you find that your physiological age is |
| | older than your actual age, you need to keep a |
| | regular daily routine that is good to your |
| | cardiovascular system. It is recommended that |
| | you formalize a daily schedule and follow the |
| | schedule as strictly as possible. The regular |
| | routine will awake your body's natural ability |
| | to regain health. |
| | 3. Tips for improving your digestive tract |
| | Sufficient ingestion of water and fiber is |
| | important to digestive health. |
| | Drinking enough water and eating grains and |
| | vegetables full of dietary fiber are of great |
| | help to prevent hardened stools and prompt |
| | gastrointestinal motility, thereby gradually |
| | improving intestinal absorption and enhancing |
| | overall health. |
| | 4. Tips for improving your muscles and bones |
| | Having a good mindset is a good start to |
| | improve physical activity. An aged body lack |
| | vitality, and engaging in heavy exercise may |
| | cause overwork and defatigation. It is |
| | important to understand that health improvement |
| | can only be successful in proper sequence. |
| | The first step is to have a right attitude, and |
| | often remind yourself of the importance of |
| | exercise. Increase exercise in terms of |
| | intensity and time gradually on a daily basis, |
| | and you will in the course of time regain |
| | basic physical strength and basal metabolism. |

Therein, the cellular-age information 610 in converted to a value of cellular age in the report. The cellular-aging index 611 is an evaluating result of cellular aging obtained using the statistical method known as stand score (z-score). The cellular-aging index may be any of seven levels namely −3, −2, −1, 0, +1, +2, and +3. The level more negative indicates a lower aging degree in the coeval population and the level more positive indicates a higher aging degree in the coeval population. In this way, the degree of cellular aging can be expressed objectively. The aging-degree evaluation 612 contains cellular-age-based evaluating results for the client's cardiovascular system, digestive tract, muscles and bones, and facial skin health according to the client's cellular-age information 610, and is used as a healthcare reference. The personal health preventive and improving recommendation 613 is preventive and improving recommendation on the client's cardiovascular system, digestive tract, muscles and bones, and facial skin aging made according to the client's cellular aging index 611, with the attempt to retard the aging process.

The user lay log in the disclosed cellular-age meta-analysis system in a wired or wireless manner and get connected to the meta-analysis server 20. The meta-analysis server 20 is connected to the user interface 10, the telomere length trend database 30, the age-telomere relation database 40, the report content database 50 and the analytic result database 70, so that the meta-analysis server 20 acts as a hub for interactive calculation and transmission of all the figures and data, and is where the meta-analysis is carried out.

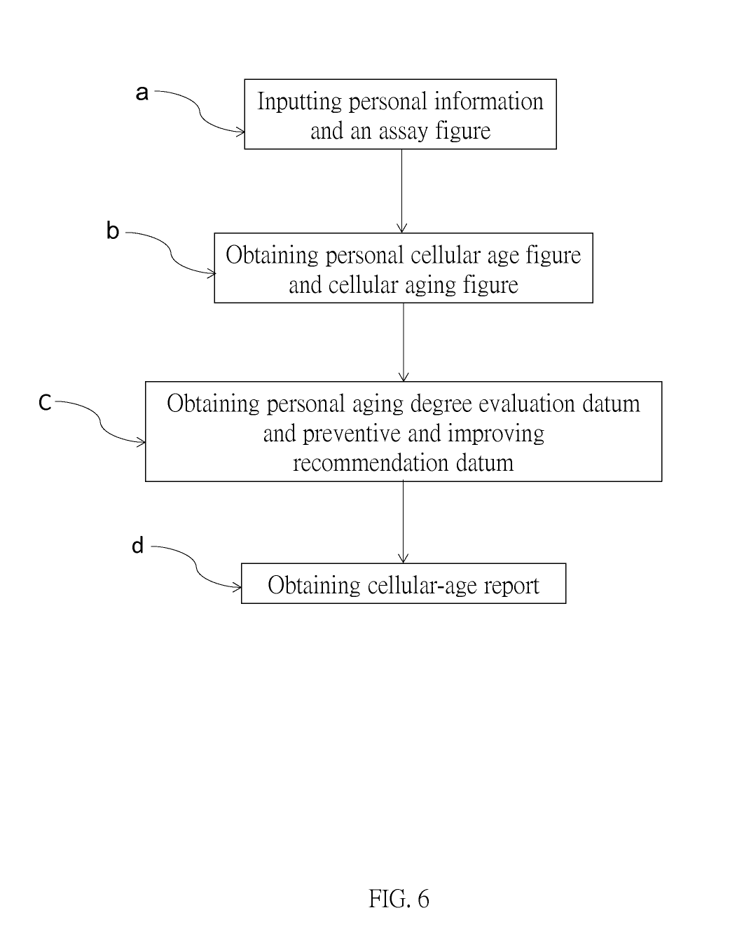

The disclosed cellular-age meta-analysis system provides a fast and reliable method for analyzing cellular aging and evaluating health. As shown in FIG. 6, the method includes the following steps. In Step a, a personal information and an assay figure are input. Particularly, a user may use the user interface 10 to input at least one personal information 11 and at least one telomere length assay figure 12 to the meta-analysis server 20.

In Step b, the personal cellular age figure and the cellular aging figure are obtained. Particularly, the meta-analysis server 20 sends the personal information 11 and the telomere length assay figure 12 to the telomere length trend database 30 and the age-telomere relation database 40, respectively. After interactive calculation, the personal cellular age figure 21 and the cellular aging figure 22 are obtained.

In Step c, the personal aging degree evaluation datum and the preventive and improving recommendation datum are obtained. Particularly, the meta-analysis server 20 further extract the personal information 11, the personal cellular age figure 21 and the cellular aging figure 22, and transmit them to the report content database 50 so that the aging-degree evaluation datum area 51 and the preventive and improving recommendation datum area 52 can perform unified calculation, thereby obtaining a personal aging degree evaluation datum and a preventive and improving recommendation datum.

In Step d, the cellular-age report is obtained. Particularly, the meta-analysis server 20 extracts the cellular aging figure 22, the personal aging degree evaluation datum and the preventive and improving recommendation datum, and performs processing and formalization so as to output a cellular-age report 60. The cellular-age report 60 provides the client with a personalized life guide for retarding aging and improving health, thereby enhancing his/her health and reducing incidence of related diseases, so as to achieve the objective of preventive medicine.

It is to be noted that the meta-analysis server 20 not only outputs the cellular-age report 60, but also save it to the analytic result database 70, so that the user can later track, retrieve and compare the analytic results at any time using the user interface 10. The meta analysis of historical figures can provide healthcare personnel with the client's improvement over time. This enables the healthcare personnel to make health consulting service and health-improving recommendation more relevant to the current situation of the client, so as to better improve the client's health and quality of life.

What is claimed is:

1. A cellular-age meta-analysis system, comprising a user interface, a meta-analysis server, a telomere length trend database, an age-telomere relation database, a report content database and an analytic result database, where:
the user interface being used to enter at least one piece of personal information and at least one telomere length assay figure to the meta-analysis server;
the meta-analysis server sending the personal information and the telomere length assay figure to the telomere length trend database and the age-telomere relation database for interactive calculation, so as to obtain a personal cellular age figure and a cellular aging figure;
the report content database receiving the personal information, the personal cellular age figure and the cellular aging figure and performing unified calculation, so as to obtain a personal aging degree evaluation datum and a preventive and improving recommendation datum; and
the meta-analysis server extracting the cellular aging figure, the personal aging degree evaluation datum and the preventive and improving recommendation datum, performing processing and formalization to output a cellular-age report, and saving the cellular-age report into the analytic result database.

2. The cellular-age meta-analysis system of claim 1, wherein the personal information includes a name, an ID number, a gender and a year of birth.

3. The cellular-age meta-analysis system of claim 1, wherein the telomere length assay figure includes an ID number, a telomere assay figure and an acidic ribosomal protein P0 gene assay figure.

4. The cellular-age meta-analysis system of claim 1, wherein the report content database includes an aging-degree evaluation datum area and a preventive and improving recommendation datum area.

5. The cellular-age meta-analysis system of claim 1, wherein the cellular-age report includes a report item set and a report content set.

6. The cellular-age meta-analysis system of claim 5, wherein the report item set includes a cellular-age information, a cellular-aging index, an aging-degree evaluation and a personal health preventive and improving recommendation.

7. The cellular-age meta-analysis system of claim 6, wherein an analytic and evaluative result of the report item set serves as a reference for a client to improve health thereof.
